(19) United States
(12) Patent Application Publication
(10) Pub. No.: US 2012/0231922 A1
(43) Pub. Date: Sep. 13, 2012

(54) MANUAL WHEELCHAIR WHEEL AND APPARATUS FOR CONTROLLING SAME

(76) Inventor: Donghwan Byun, Seoul (KR)

(21) Appl. No.: 13/510,284

(22) PCT Filed: Nov. 17, 2009
(86) PCT No.: PCT/KR2009/006761

§ 371 Date: May 16, 2012

(51) Int. Cl. F16H 3/44

(52) U.S. Cl. 475/312; 475/311

(57) ABSTRACT

The present invention relates to a manual wheelchair wheel, and in particular, to a manual wheelchair wheel with a built-in geared hub through which the speed of a forward or reverse driving force is shifted and said driving force is transferred, and which has an anti-reverse function, wherein the wheel is light and can easily replace existing wheelchair wheels. The wheel comprises: a central shaft having an axial direction hole and a radial direction through-hole and installed so as to not rotate with respect to the frame of the wheelchair; an input member supported on the central shaft and coupled to and rotated together with a handrim; an output member supported on the central shaft and coupled to and rotatable together with the wheel; a planetary gear column including a plurality of planetary gears installed on either the input member or output member, at least one sun gear engaged with a planetary gear, and a ring gear installed on the other one of the input member and output is member and engaged with a planetary gear; at least one shifting clutch enabling or preventing the rotation of the sun gear; a lock-up clutch enabling the input member and the output member to be coupled together and rotate in concert or be disengaged and rotate freely with respect to one another; and a shifting cam rotatably installed in the axial direction hole of the central shaft in order to control the operation of the shifting clutch and the lock-up clutch, wherein a different clutch operates according to the rotating direction/position of the shifting cam to shift between two or more gears and transfer forward and reverse driving force from the handrim to the wheel.

### TECHNICAL FIELD

The present invention relates to a manual wheelchair wheel, and in particular to a manual wheelchair wheel in which a forward movement drive and a backward movement drive can be speed-changed and transferred by way of an internal gear hub, and which has a backward movement prevention function and is light and can be easily substituted with an existing wheelchair wheel.

### BACKGROUND ART

A lot of wheelchair users wish to do something independently without is having helps from others during a common life like working at an office or doing an avocation. There however are lots of obstacles hindering a user from doing an independent activity now that there are topographical features such as ramps, mounds connecting the inner and outer sides of a house, lawns and sandy beach, which are generally not flat and make its movement hard. The conventional manual wheelchair is inefficient as a transportation means. A lot of users feel difficulties in effectively driving a manual wheelchair in case that they have injuries or less arm power or they are hard to keep a proper posture for driving the wheelchair.

According to some researches, it is known that a driving efficiency of a wheelchair accounts for about 5%˜18%. The low efficiency of a manual wheelchair makes the effective use of a wheelchair difficult or impossible. Since the users of the wheelchairs generally use the joints and muscles of their upper body, lots of physical fatigues and injuries occur, for example, the injury dangers such as a hand muscle compression syndrome or a rotator cuff tenonitis of a to shoulder exceed 50% (3% in case of ordinary person). The longer the wheelchair is used, the more the pain occurrence ratio increases. As the user ages, the cardio pulmonary function is worsened. It is needed to develop an alternative which is able to resolve the problems which occur as the wheelchair is driven with a hand rim.

In order to overcome the above problems, various tests have been conducted domestically or overseas using level-drive units, crank-drives and geared hubs for bicycle; however none of the above apparatuses are not solutions which could be actually, widely and commercially adapted. If a bicycle speed change system was adapted to a wheelchair, all the problems could be overcome at a time; however the bicycle speed change system is possible only for a forward movement, but the backward movement is impossible, so it cannot be adapted to the wheelchair. It therefore is needed to develop a wheelchair which can be driven by a hand rim driven by a small force from a user now that is equipped with a two-way driving function and a speed change function, at the same time, it is needed to develop a wheelchair with a backward movement prevention function.

It is sure that a user might have a high economical burden if a user needs to by a new wheelchair because it is impossible to adapt to a developed device to an existing wheelchair, which results in a consumption of resource. So, it is also needed to develop a fixing device which helps exchange a manual wheelchair wheel with the wheel of an existing wheelchair, the manual wheelchair wheel having the above mentioned functions without changing the frames of an existing wheelchair irrespective of the standard type wheelchair fixedly engaging the wheels and the advanced type wheelchair detachably engaging the wheels.

### DISCLOSURE OF INVENTION

Accordingly, it is an object of the present invention to provide a manual wheelchair wheel which can be driven in a forward direction and a backward direction, namely, in both directions, and is equipped with a speed change function.

It is another object of the present invention to provide a manual wheelchair wheel having a backward movement prevention function.

It is further another object of the present invention to provide a manual wheelchair wheel having a wheelchair wheel and a fixing member which help exchange a manual wheelchair wheel proper for the above-mentioned objects with an existing wheelchair wheel without changing the frame of an existing wheelchair.

It is still further another object of the present invention to provide a fixing member and a manual handle which facilitate the concurrent adjustments of left and right wheels in a wheelchair equipped with a manual wheelchair wheel proper for the above-mentioned objects.

To achieve the above objects, there is provided a manual wheelchair wheel which comprises a central shaft which has an axial direction is hole and a radius direction through hole and is installed in such a way not to rotate with respect to a frame; an input member which is supported by means of the central shaft and is engaged with a hand rim and rotates together with the same; an output member which is supported by means of the central shaft and is engaged with the wheel and rotates together with the same; a planetary gear train which includes a plurality of planetary gears which are installed either at the input member or the output member; at least one sun gear which is engaged with the planetary gear; and a ring gear which is installed at another one and is engaged with the planetary gear; and at least one speed change clutch which involves in a rotation possible operation and a rotation impossible operation of the sun gear; a direct connection clutch which involves in an operation that the input member and the output member are engaged and rotate together and they are disengaged and rotate separately; and a speed change cam which is rotatably installed at an axial direction hole of the central shaft and controls the operations of the speed change clutch and the direct connection clutch, whereby a clutch different from one another can operate depending on the rotation direction position of the speed change cam, so the forward and backward movements of the hand rim can be transmitted with at least two speed change stages and are transferred to the wheels, respectively.

The speed change clutch comprises a sun gear which has a is plurality of protrusions protruded in an axial direction or a radius direction; a speed change clutch ring which has a plurality of protrusions surrounding the central shaft and engaging with or disengaging from the protrusions and is installed to move side by side in an axial direction and not to rotate; and an elastic member which pressurizes for the speed change clutch ring to move an engaging position.

The direct connection clutch comprises an input member and an output member which each have a plurality of protrusions at the facing side surfaces in an axial direction or a radius direction; a rotation clutch ring which surrounds the central shaft and includes a plurality of protrusions which are to engage with or disengaged from the protrusions and rotates together with either the input member or the output member and is engaged to slide in an axial direction; a guide ring which moves side by side in an axial direction and is installed not to be rotatable and comes into contact with the rotation clutch ring; and an elastic member which pressures the rotation clutch to move an engaging position. It is preferred that a bearing is disposed between the non-rotating guide ring and the rotating clutch ring.

The speed change cam comprises a first axial direction cam surface which is engaged with the speed change clutch ring or the guide ring by way of the radius direction through hole of the central shaft, and guides the is speed change clutch ring to a disengagement position depending on the rotation direction position of the speed change cam, and allows the same to move to the engaging position; and a second axial direction cam surface which guides the rotation clutch ring to a disengagement position which allows the movement to the engaging position.

Here, the guiding means a forced movement coming into contact with the cam surface. The movement allowance means that a cam surface is formed at a position where to move to, and it is pressurized by an elastic member and is moved to a targeted position.

It is preferred that the elastic member is a coil spring or a wave washer. The elastic member plays a key role in making the speed change cam rotate sooth. In other words, when the speed change cam is rotated, the end portions of both protrusions of the clutches, which are supposed to be engaged with each other while the clutches are engaged, come into contact with each other. At this, the elastic member helps the speed change cam rotate to irrespective of the engagement or disengagement.

It is preferred to control the rotation direction position of the engaging member guide plate by further providing a braking member which is installed not to be rotatable with respect to the central shaft for the purpose of selectively preventing a backward movement of a wheelchair and has a plurality is of pockets at an outer surface, with each pocket having a driving force transfer surface; an output member which surrounds the braking member and has a driving force transfer surface at an inner surface; a plurality of engaging members which are installed at each pocket and fit while coming into contact with the two driving force transfer surfaces; an elastic member which is so configured to pressurize in a rotation direction that the engaging member can move backward in order for the engaging member to come into contact with the two driving force transfer surfaces; and an engaging member guide plate which guides the engaging member not to come into contact with at least one surface between the two driving force transfer surfaces.

The central shaft comprises a frame support part which passes through a through hole formed at the frame and supports the frame; a speed change part which accommodates the speed change cam and rotatably supports the input member and the output member; and a fixing part which fixes the central shaft not to rotate, whereby the central shaft is engaged not to disengaging from the frame and not rotating.

In order to constitute a manual wheelchair wheel which can be quickly engaged to a frame or can be quickly disengaged from a frame, it is preferred to comprise an ejector pin which is arranged passing through the speed change cam having the central shaft and the hole; and an end portion of is the central shaft which size-decreases enough to freely pass through the through hole of the frame when an axial direction pressure is applied to the ejector pin, and expands when the pressure is not applied to the ejector pin, so that it can be stably fixed at the through hole of the frame.

In order for the wheelchair wheel to be adapted to a through hole of each of various wheelchair frames, it is preferred that the frame support part of the central shaft and the speed change part are provided in a prefabrication type, so the device can be applied to the through holes of various wheelchair frames in such a way to exchange only the frame support part formed in a cassette form.

It is preferred that the output member operates like a hub surrounding the central shaft, the input member, the planetary gear train, the speed change clutch, the direction connection clutch and the speed change cam.

The method of speed-changing from the side of the vehicle by protruding a speed change shaft to the outside of the wheel can be easily achieved; however it is needed to control separately the left and right wheelchair wheels. In order to separately control the left and right wheelchair wheels, it is preferred to control the rotation direction position of the speed change cam with the aid of a protrusion protruded from the speed change cam toward the portion opposite to the frame via the central shaft and the speed change lever engaged to the protrusion. It is preferred that the engaging member guide plate controls the rotation direction position of the engaging member guide plate by means of the braking link rotatably passing through the speed change cam past the central shaft and the braking lever engaged to the link.

However, since the speed change lever and the braking lever are separately provided at the outer side of the frame, the operation is not easy, and as the lever might be transformed by a surrounding environment during the operation of the wheelchair, or the operation of the wheel chair might be interfered. The unbalance of both wheels which occurs when not controlling both wheels concurrently is inevitable. So, the above mentioned unbalance is not preferable because it might cause the running direction to change.

It is preferred that the speed change lever and the braking lever are integrally controlled at their left and right sides in the frame. In order to concurrently control the left and right wheelchair wheels in the frame, it is preferred that the speed change cam has an elastic member pressing in one rotation direction so that the position of one side toward the rotation direction is maintained, and the left and right wheels are arranged symmetrically. It is preferred that there are provided a speed change pin which is protruded from is the speed change cam toward the direction of the frame via the central shaft, a central shaft having a through hole allowing the speed change pin to move in the rotation direction, and a control device helping control the rotation direction position of the speed change cam in the frame. The engaging member guide plate comprises a control device having a protrusion protruded toward the direction of the frame, thus helping control the rotation direction position of the engaging member guide plate in the frame.

It is preferred that the speed change cam is pressed in one rotation direction by means of the elastic member so that either one direction in the direction of the rotation can be maintained, the construction of which can properly work when aligning the positions at the time the detachable wheelchair wheels are engaged.

Therefore the control device is engaged at both sides of the frame and is connected with a handle of one control device by way of a connection means formed of a wire or the like from a connection part of the control device accommodating the protrusion or the speed change pin in a form opposite to each wheel and a connection part of the control device installed at both sides, thus concurrently controlling both wheels.

It is preferred that both the wheels can be concurrently controlled with the handle by providing a wheel fixing device which supports the central is shaft of the wheelchair wheel not to rotate; a connection part of the control device which surrounds a speed change ring surrounding the wheel fixing device and accommodating the speed change pin and the wheel fixing device and accommodates a protrusion controlling the backward movement prevention function; a handle manipulating the control device; and a link connecting the connecting part and the handle. It is preferred that the connection part of the control device is connected to a handle via a wire and is engaged in such a way that a wire is pulled or loosened as the handle rotates, and the speed change ring and the braking ring each comprise a return spring applying a force in the direction that each wire is wound.

It is preferred that the handle comprises a tensional force adjusting bolt which is surrounded by a tube and accommodates the wire by passing through the same and supports an end of the tube; a bracket which has a female thread accommodating the tensional force adjusting bolt; a speed change handle which is engaged with the speed change ring by way of a wire; and a braking handle which is engaged with the baking ring by way of a wire, whereby the tensional force can be adjusted by tightening or loosening each tensional force adjusting bolt.

### ADVANTAGEOUS EFFECTS

The manual wheelchair wheel according to the present invention has functions: 1) it can be driven in both directions and has a speed change function, and 2) it has a backward movement prevention function, and 3) it is possible to exchange a manual wheelchair wheel with the above-mentioned functions 1) and 2) with the wheel of an existing wheelchair without changing the wheelchair body. 4) In addition, the present invention provides a fixing member and a manual handle at a wheelchair with a manual wheelchair wheel having the above-mentioned functions 1), 2) and 3), the fixing member and the manual handle being able to concurrently adjust the left and right wheels. At the same time, the structure looks simple and is light and can be quickly detached from the frame.

### BRIEF DESCRIPTION OF DRAWINGS

FIG. 1 is a perspective view illustrating a manual wheelchair wheel according to an embodiment of the present invention.

FIG. 2 is a perspective view illustrating a state that an example of a manual wheelchair wheel and a fixing member and an adjusting handle assembly according to the present invention are engaged to a frame.

FIG. 3 is a perspective view illustrating a back side of FIG. 1.

FIG. 4 is a disassembled perspective view of FIG. 1.

FIG. 5 is a cross sectional view of a shaft of FIG. 1.

FIG. 6 is a cross sectional view taken along line B-B of FIG. 5.

FIG. 7 is a cross sectional view taken along line C-C of FIG. 5.

FIG. 8 is a perspective view illustrating a state that an example of a manual wheelchair wheel fixing device and a connection part of a control device according to the present invention are engaged to a wheel chair.

FIG. 9 is a disassembled perspective view of FIG. 8.

FIG. 10 is a partial cross sectional view for explaining a speed change part of FIG. 8.

FIG. 11 is a partial cross sectional view for explaining a braking of FIG. 8.

FIG. 12 is a perspective view illustrating a handle part of a manual wheelchair wheel control device according to the present invention.

FIG. 13 is a cross sectional view illustrating a shaft of a manual wheelchair wheel with a quick detaching central shaft according to another embodiment of the manual wheelchair wheel according to the present invention.

### MODES FOR CARRYING OUT THE INVENTION

The terms or words used in the present specification and claims should not be interpreted as a conventional or dictionary-based meaning for is restrictive purposes, and they should be interpreted as meaning and concepts matching with the technical concepts of the present invention based on the principle that the inventors can define the concepts of the terms in the most effective ways for the purpose of describing his invention in the best way.

So, the constructions provided in the embodiments and drawings of the present invention are provided as the most preferred embodiments of the present invention, not presenting all the technical concepts of the present invention, so it should be understood that there might be various equivalents and modifications which might substitute the same at the time the invention is made.

The preferred embodiments of the present invention will be described with reference to the accompanying drawings.

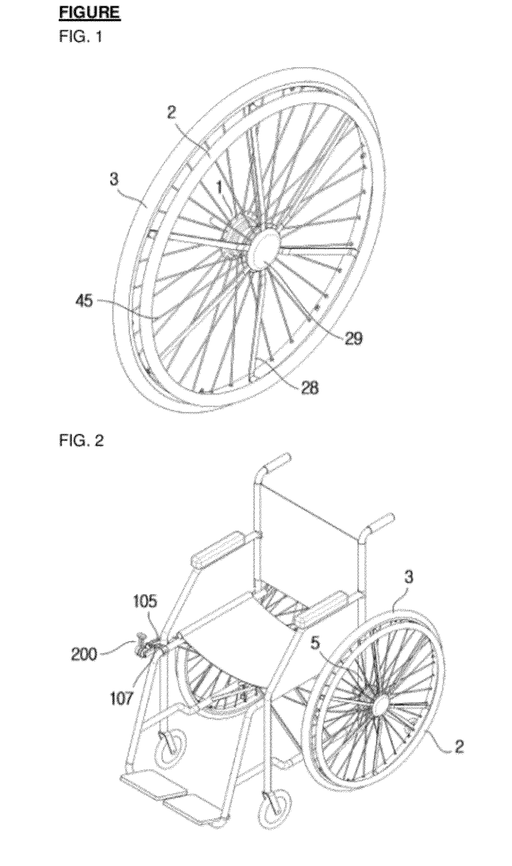

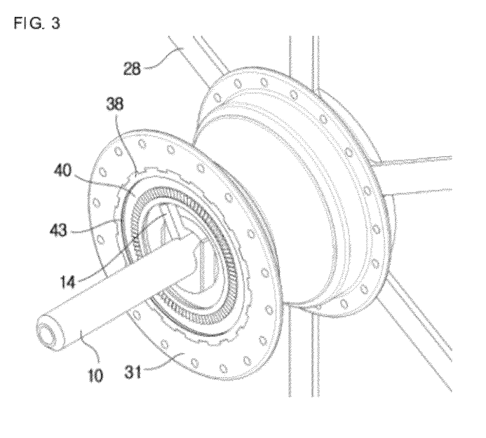

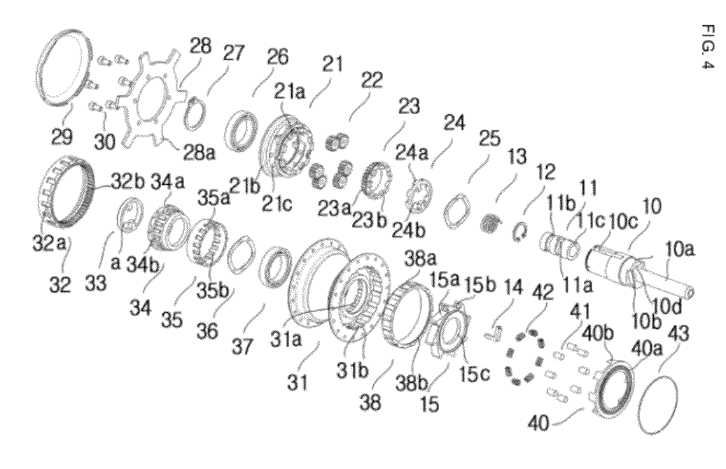

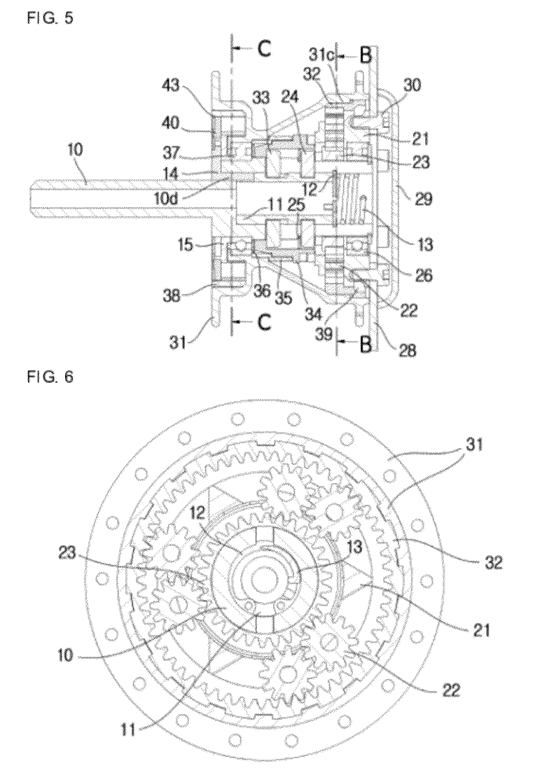

FIG. 1 is a perspective view illustrating a manual wheelchair wheel according to an embodiment of the present invention. FIG. 3 is a perspective view illustrating a back side of the above example. FIG. 4 is a disassembled to perspective view of the above example. FIG. 5 is a cross sectional view of a shaft of the above example. FIG. 2 is a perspective view illustrating a state that the above example is engaged at the frame.

The central shaft 10 of the manual wheelchair wheel according to the is present invention is characterized in that a support part 10a with a small radius supporting the frame 5 via a through hole formed at the frame 5 is formed at its one end, and a thread is formed at its surface for the purpose of fixing the central shaft 10. In addition, a deep hole is formed at the center of the shaft in an axial direction for the purpose of accommodating a speed change cam 11. There is provided a central part with a large radius in which bearings 26 and 37 are disposed for the purpose of rotatably supporting a planetary carrier 21 which is an input member, and a hub 31 which is an outer member.

At the center of the same is formed a clutch guide groove 10c deep grooved in a radius direction. A shoulder 10e is provided for a bearing which supports the hub 31. The clutch guide groove 10c serves to help guide the speed change clutch ring 24 and the guide ring 33 to move side by side in an axial direction without rotations. A protrusion 10b is formed between the center and the support part 10a and is protruded in an axial direction. Part of a principle plane of the protrusion is formed of a flat surface 10b, and a thread is formed at the principle plane. The protrusion is engaged with the braking member 15 by way of the threads, thus fixing the bearing 37. The braking member 15 is characterized in that since a force hindering the rotation of the backward direction is applied thereto, a left thread and a right thread are formed at the central shafts 10 of the left and right wheels for the purpose of ensuring that the braking member 15 is not loosened.

A through hole 10d is formed at part of a side wall of the axial direction of the protrusion and is extended to the hole accommodating the speed change cam 11, so the speed change cam 11 can be connected from the outside of the central shaft 10. On the principle plane is formed a radius direction through hole 10g supporting the coil spring 13 which pressurizes in a rotation direction the snap ring groove 12 and the speed change cam 11 which supports in an axial direction the speed change cam 11 not to move in the axial direction. The central shaft 10 might be formed in one body; however it is manufactured separately from the central part 10e and the support parts 10a and 10k, so they are engaged with one another using threads.

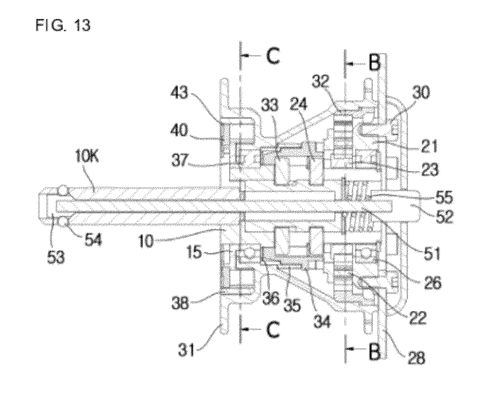

The thread of the support part 10a fixing the central shaft 10 is stably fixed at the frame 5 by means of the nut. In this case, it might be hard to attach or detach the wheels. When it is needed to quickly attach or detach the wheels, as shown in FIG. 13, quick attaching and detaching devices 10k, 51, 52, 53, 54 and 55 might be utilized.

The speed change cam 11 is inserted into the deep groove of the central shaft 10 and rotates therein, thus controlling the speed change clutch 23, 24 and the direction connection clutch 21, 34. At the outer surface of the speed change cam 11 are provided a cam guide surface 11b for the speed change clutch ring 24 operating the speed change clutch 23, 24 and a cam guide surface 11a for the guide ring 33 operating the direct connection clutch 21, 34. Two cam guide surfaces 11a and 11b are formed in such a way that each groove is formed where the corresponding clutch is engaged. At a side wall of one side of each groove is formed a cam guide surface which is low sloped in an axial direction. Two cam guide surfaces 11a and 11b are sloped in opposite directions. When one cam guide surface is grooved deepest, the other cam guide surface is not grooved in an axial direction, so two clutches can operate at different angles. Each angle is 30°-90°. At an end portion of the speed change cam 11 is formed a groove accommodating one end portion of the coil spring 13. At the opposite end portion is formed a groove 11c accommodating the speed change pin 14.

The speed change pin 14 is a L-shaped member and is engaged with the speed change cam 11 via an axial direction through hole of the central shaft 10 which orients toward the inside of the frame 5 and is accommodated in the speed change ring 102 engaged at the frame 5, thus controlling the speed change cam 11. The speed change pin 14 might be engaged with the speed change cam 11, so it can be protruded outwardly from the frame 5. At this time, each wheel can be speed changed from the outside of each wheel.

One end portion of the coil spring 13 is bent in an axial direction so is that it can be engaged with one side groove of the speed change cam 11, and the other end portion of the same is bent at a radius direction so that it can be engaged with a through hole 10g of the central shaft 10. The coil spring 13 is assembled to be supported by the central shaft 10, thus pressurizing the speed change cam 11 in one rotation direction. At this time, the speed change pin 14 serves to limit the rotation of the rotation direction. It is used for the purpose of arraying the positions when the detachable wheelchair wheels are engaged, so the pressurizing directions of the left and right wheels are arranged to be symmetrical from each other.

The input carrier 21, which is an input member, is supported by the bearing 26 and rotates and comprises three through holes 21b at one side in a radial shape for the purpose of accommodating the planetary gear 22. At an outer surface of the opposite side is formed a bearing surface 21c which supports the hub 31 which is an output member, and at a side surface is formed a bolt hole 30 engaging the hand rim adapter 28 which is engaged with the to hand rim 2. At the opposite surface are formed a plurality of protrusions 21a in a radial shape in an axial direction for the purpose of being engaged with or disengaging from the rotation clutch ring 34.

The planetary gear 22 is a double pinion gear two of which are engaged in the through hole of the input carrier 21: one of the same has a small is radius and is engaged with the sun gear 23 and the other one of the same has a large radius and is engaged with the ring gear 32.

The sun gear 23 engaged with the planetary gear 22 has a through hole for the sun gear 23 to rotate surrounding the central shaft 10, and a plurality of protrusions 23b protruded in the axial direction are uniformly formed at the side surface for them to engage with or disengage from the speed change clutch ring 24. The sun gear 23 is generally supported in the axial direction with the aid of a snap ring or a stop ring or something for rotation while maintaining the positions without movements in the axial direction.

The speed change clutch ring 24 has a cam surface helping for the protrusion 24b protruded toward the center to come into contact with the cam guide surface 11b of the speed change cam past the through groove of the radius direction of the central shaft 10 and is like a cylindrical ring which slides side by side in the axial direction along the central shaft 10 and does not rotate. At the side of the ring are uniformly provided a plurality of protrusions 24a to protruded in the axial direction in a way to engage with or disengage from the protrusions 23b of the sun gear.

The wave washer 25 which is an elastic member pressurizing the speed change clutch ring 24 toward the sun gear 23 serves to pressurize the speed change clutch ring 24 in the axial direction as it is supported by a stair-shaped shoulder formed at the central shaft 10. The wave washer 25 serves to help pressurize the speed change clutch ring 24 for the purpose of preventing the engagement from disengaging when the speed change clutch ring 24 is engaged with the protrusion of the sun gear 23. The wave washer 25 has an elongation force strong enough to obtain a transfer distance by which the speed change clutch ring 24 is not interfered with the protrusion of the sun gear 23 when the engagement is guided to the position where disengagement occurs due to the speed change cam 11.

In the preferred embodiments of the present invention, each protrusion is formed to have a height of 1-4 mm, so the cam surface of the speed change cam 11 is formed to have a stepped portion of 1-4 mm, and the wave washer is designed to have an elongation force of above 1-4 mm.

The hub 31 which is an output member rotates being supported by the bearing 37, at an inner surface of which hub are fixedly engaged the ring gear 32 and the direct connection clutch ring 35 and the braking ring 38, and at an outer surface of which hub is fixedly engaged a wheel by way of a spoke.

The hub 31 surrounding the side surface and outer surface of the bearing 37 is tightly engaged not to move as the protrusion 31a protruded in a radius direction is formed in a radial direction at an inner surface and is engaged with the protrusion 35a of the direct connection clutch ring. At an end portion of one is side of the hub 31 expanded in a conical shape is formed a protrusion 31c protruded at an inner surface in a radius direction, in a radial direction, so the protrusion 31c is engaged with the protrusion 32a of the ring gear, thus obtaining its stable engagement. At the side wall of the hub 31 expanded in a radius direction and surrounding the ring gear 32 are formed a plurality of spoke holes 31d for a connection with the wheel. In addition, an outer surface of the hub 31 surrounding the bearing 37 is expanded in a radius direction and surrounds the braking ring 38 in an axial direction and then is expanded in a radius direction again. At a side wall of the expanded hub 31 are formed a plurality of spoke holes 31e for a connection with the wheel. At an inner surface of the hub 31 surrounding the braking ring 38 in an axial direction is formed a protrusion 31b in a radius direction, which protrusion is engaged with the protrusion 38a of the braking ring, so it is tightly engaged without rotation.

The ring gear 32 has an inwardly threaded gear 32b engaged with the pinion gear 22, and a plurality of protrusions 32a formed at an outer surface for an engagement with the hub 31c in a non-rotatable manner. At a cylindrical inner surface expanded in a lateral direction is formed a bearing surface 32c, thus rotatably supporting the hub 31 in cooperation with the bearing surface 21b of the input carrier.

The direct connection clutch ring 35 has a radial protrusion 35a at is one side of an outer surface for an engagement with the hub 31a in a non-rotatable manner. A radial direction protrusion 35b is formed in a radial shape at an end portion of the inner surface for an engagement with the rotation clutch ring 34b as it slides in an axial direction.

The rotation clutch ring 34 is a cylindrical member and rotates along with the direct connection clutch ring 35 and moves side by side by means of the guide ring 33 and the elastic member 36 and freely rotates as it rotates in an engagement with the input carrier 21 or it is disengaged. A circular plate is formed at an end portion of one side of the rotation clutch ring 34 and slides surrounding the central shaft 10 and comes into contact with the guide ring 33 at an end portion of the circular plate while surrounding the same. At an outer surface of the central portion expanded in an axial direction is formed a radius direction protrusion 34b in a radial shape for an engagement with the protrusion 35b of the direct connection clutch ring in such way that it slides in an axial direction, but does not relatively rotate. At the other end portion are uniformly to formed a plurality of protrusions 34a protruded in an axial direction for an engagement or disengagement with the protrusion 21a of the input carrier.

The guide ring 33 comprises a cam surface 33a helping the protrusion 33a protruded toward the center to come into contact with the cam guide surface 11a of the speed change cam past the radius direction through groove 10c of the central shaft and is like a cylindrical ring which does not rotate as it slides side by side in an axial direction along the central shaft 10. The guide ring 33 limits the rotation clutch ring moves in an axial direction toward the input carrier as it comes into contact with an inner side surface of the circular plate of the rotation clutch ring 34 by way of the bearing.

The wave washer 36 which is an elastic member pressurizes the rotation clutch ring 34 in an axial direction as it is supported by the bearing 37. The wave washer 36 serves to help the engagement not to disengage by pressurizing the rotation clutch ring 34 even when the rotation clutch ring 34 is engaged with the protrusion of the input carrier 21. It has an elongation force strong enough to obtain a transfer distance up to the position where the rotation clutch ring 34 and the protrusion of the input carrier 21 can rotate without interference with each other when it is guided to a position where the engagement is disengaged by means of the guide ring 33.

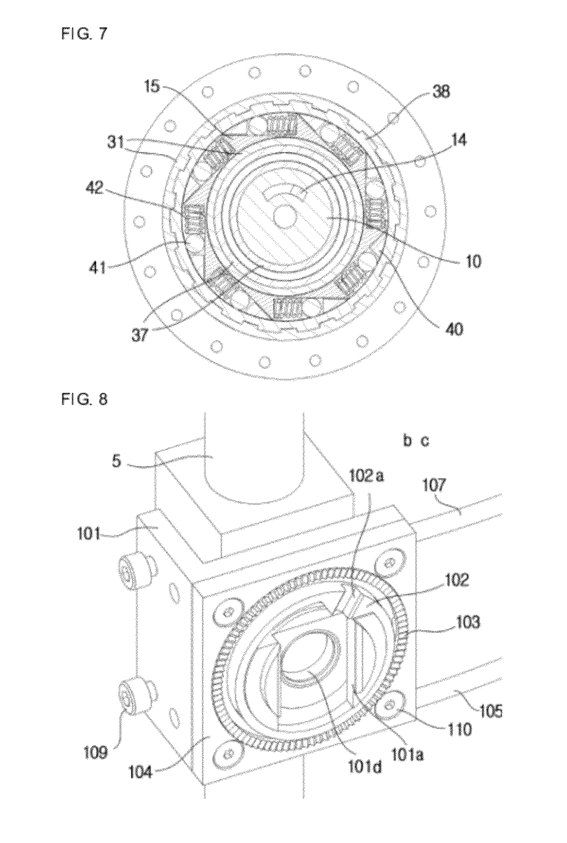

The braking part capable of selectively preventing the backward movement, as shown in FIG. 7, is characterized in that one direction clutch is installed between the hub 31 and the fixed central shaft 10 which is the output member. The braking member 15 fixed at the central shaft 10 forms eight pockets at the outer surface for thereby accommodating the engaging member 41, and a driving force transfer surface 15a is formed at one side of the pocket. The other side surface 15b serves to support the elastic member 42 pressurizing the engaging member. The driving force transfer surface 15a is arranged in a rotation direction that the wheels 3 move backward. The inner surface 15c has a thread and is thread-engaged with the central shaft 10 by pressurizing the bearing 37. The thread is designed to be tightened in the rotation direction that the wheels 3 move backward, thus preventing the loosening of the threads.

The engaging member 41 is a cylindrical roller which is pressurized by the elastic member 42 between the driving force transfer surface 15a of the braking member and the driving force transfer surface of the braking ring 38 fixed at the hub 31 and fits while coming into contact with the two driving force transfer surfaces.

The engaging member pressurizing spring 42 which is an elastic member is a plate spring formed by forming a coil spring or a thin plate and has a weak elastic force for the purpose of a little coming into concurrent contact with the two driving force transfer surfaces.

The engaging member guide plate 40 is supported at an inner surface of the braking ring by means of a stop ring and is rotatably arranged, and the protrusion 40b protruded in an axial direction between the two driving force transfer surfaces of the engaging member 41 and the braking member 15 comes into contact with the engaging member 41 by means of rotation. As the engaging member guide plate rotates in the forward movement direction in order for the engaging member not to come into concurrent contact with the two diving force transfer surfaces. In addition, at the side surface is formed a protrusion 41a for an engagement with the braking ring 103 of the wheel control device.

So, the central shaft 10 and the speed change cam 11, and the braking member and the engaging member guide plate are arranged to be paired at the left and right sides, so the left and right wheels are recognized.

The wheel fixing device 101 installed at the wheelchair frame 5 for the purpose of engaging with the wheelchair wheel 1 is characterized in that an axial direction protrusion 101c is formed, and a through hole 101d is formed so as to accommodate the support part 10a of the central shaft, and an axial direction groove 101a is formed so as to accommodate the axial direction protrusion 10b of the central shaft and so as to support the same not to rotate and a plane 101b is formed at one side of the outer surface. The wheel fixing device 101 is fixed to the frame by way of a bolt or a protrusion depending on the design specifications of various wheelchairs.

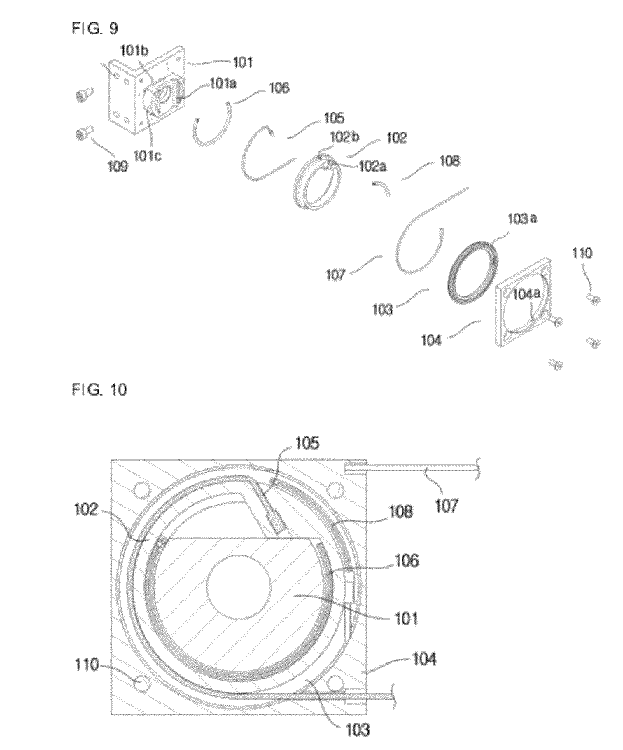

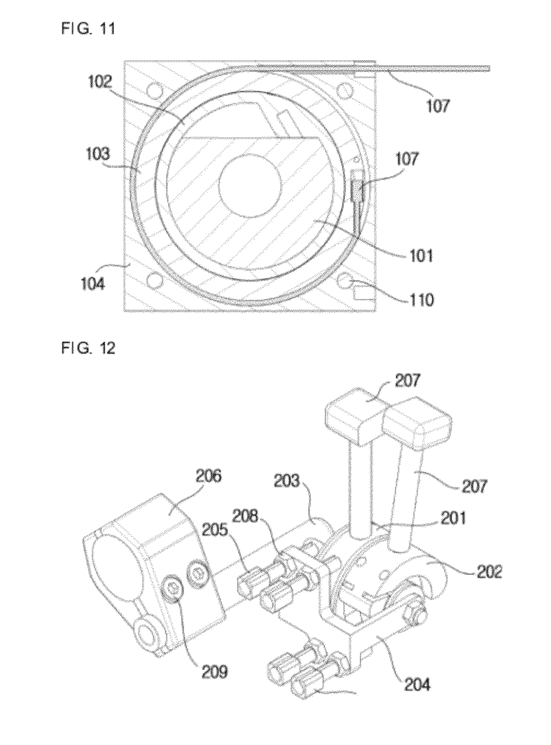

The wheel control device will be described with reference to FIGS. 8 to 12. The wheel control device comprises a speed change part, a backward is movement prevention part and a handle part.

The speed change ring of the speed change part rotates surrounding the protrusion 101c of the wheel fixing device and has a protrusion 102a at an inner surface for the rotation to be limited within a certain angle range and has a groove 102a accommodating the speed change pin 14, and at the opposite side of the speed change ring, the speed change wire 105 is accommodated and fixed (102b), and it can rotate as the speed change wire 105 is pulled. In addition, there is further provided a return spring 106 for the purpose of making the same return to an initial position when the force puling the speed change wire 105 disappears.

The braking ring 103 of the backward movement prevention part comprise a plurality of axial direction protrusions 103a for an engagement with the engaging member guide plate 40 and is rotatably arranged between the connection part cover 104 and the speed change ring 102. The rear side of the same is constructed in such a way that it can rotate by accommodating and fixing the braking wire 107 as the braking wire 107 is pulled. In addition, there is further provided a return spring 108 for the purpose of making the same return to an initial position when the force puling the braking wire 107 disappears.

The handle part is configured in such a way that a speed change handle 207a and a braking handle 207b are arranged, and speed change wires 105a and 105b and braking wires 107a and 107b are connected from both wheels, respectively, thus concurrently controlling the both wheels 1a and 1b. Each of the wires 105a, 105b, 107a, and 107b is fixed at the handle 207 by way of the tensional force adjusting bolt 205 for the purpose of having a proper tensional force, and the position of the tensional force adjusting bolt 205 is determined by means of a tensional force adjusting bolt fixing nut 208.

The operations of the present invention will be described.

For the functions such as the standard wheelchair, the speed change handle is positioned at the position of the direct connection, and the braking handle is positioned at the no backward movement prevention.

The speed change handle is loosened and the wire is also loosened, so the speed change pin and the speed change cam engaged with the speed change ring is positioned at a direct connection position by means of the springs 13 and 106, and the direct connection clutch (guide ring) cam surface of to the speed change cam is positioned at a portion where the guide ring allows a forward movement, and the protrusion of the rotation clutch ring moves forward to the portion where to engage with the input carrier protrusion by means of the spring 36. At the same time, the speed change clutch cam surface of the speed change cam guides the speed change clutch ring to the portion where the is protrusion of the speed change clutch ring disengages from the protrusion of the sun gear. At the same time, the braking wire engaged with the braking handle keeps a tensely pulled connection state. The braking wire allows the engaging member guide plate engaged with the braking ring to rotate, so the protrusion of the engaging member guide plate pushes the engaging member and rotates, so the engaging member does not fit by contacting with only one between the braking ring and the braking member, whereby the hub can rotate in a backward direction, so the forward and backward movements are possible.

When the backward movement prevention braking handle is loosened and is positioned at the backward movement prevention operation position, the engaging member guide plate engaged with the braking ring moves while pushing the protrusion of the engaging member guide plate so that the engaging member is positioned at the fitting position between the braking ring and the braking member by means of the pressurizing force of the braking spring at the time the tensional force of the braking wire has disappeared. The to forward direction movement rotation is possible, but in terms of the backward direction rotation, since the braking member fits, the central shaft and the hub are engaged, so the hub does not rotate along with the central shaft.

When the speed change handle is positioned at the deceleration position, the speed change wire is pulled, and the speed change pin engaged with the speed change ring and the speed change cam rotate to be at the deceleration position, and the direct connection clutch (guide ring) cam surface of the speed change cam guides a guide ring to the portion where the engagement between the protrusion of the rotation clutch ring and the protrusion of the input carrier is disengaged. At the same time, the speed change clutch cam surface of the speed change cam is positioned at the portion where the speed change clutch ring allows a forward movement, and the protrusion of the speed change clutch ring moves forward to the portion where the protrusion of the speed change clutch ring is engaged with the protrusion of the sun gear by means of the spring 25. As for the sun gear, the rotation stops by means of the speed change clutch ring, and the planetary gear train operates, and the hub decelerates and rotates.

When it is positioned at the position of the no operation of the backward movement prevention by pulling the backward movement braking handle, the engaging member guide plate engaged with the braking ring rotates by means of the wire, and at the same time, as the protrusion of the engaging member guide plate pushes the engaging member and rotates, the engaging member positioned at the fitting position between the braking ring and the braking member does not come into contact with and fit with only one between the braking ring and the braking member, so the hub can rotate in the backward is movement direction, so it can move forward as well as backward.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A manual wheelchair wheel engaged to a frame of a manual wheelchair, comprising:
a central shaft which has an axial direction hole and a radius direction through hole and is installed in such a way not to rotate with respect to a frame;
an input member which is supported by means of the central shaft and is engaged with a hand rim and rotates together with the same;
an output member which is supported by means of the central shaft and is engaged with the wheel and rotates together with the same;
a planetary gear train which includes:
a plurality of planetary gears which are installed either at the input member or the output member;
at least one sun gear which is engaged with the planetary gear; and
a ring gear which is installed at another one and is engaged with the planetary gear; and
at least one speed change clutch which involves in a rotation possible operation and a rotation impossible operation of the sun gear;
a direct connection clutch which involves in an operation that the input member and the output member are engaged and rotate together and they are disengaged and rotate separately; and
a speed change cam which is rotatably installed at an axial direction hole of the central shaft and controls the operations of the speed change clutch and the direct connection clutch, whereby a clutch different from one another cam operate depending on the rotation direction position of the speed change cam, so the forward and backward movements of the hand rim can be transmitted with at least two speed change stages and are transferred to the wheels, respectively.

2. A manual wheelchair wheel according to claim 1, wherein said speed change clutch comprises:
a sun gear which has a plurality of protrusions protruded in an axial direction or a radius direction;
a speed change clutch ring which has a plurality of protrusions surrounding the central shaft and engaging with or disengaging from the protrusions and is installed to move side by side in an axial direction and not to rotate; and
an elastic member which pressurizes for the speed change clutch ring to move an engaging position.

3. A manual wheelchair wheel according to claim 1, wherein said direct connection clutch comprises:
an input member and an output member which each have a plurality of protrusions at the facing side surfaces in an axial direction or a radius direction;
a rotation clutch ring which surrounds the central shaft and includes a plurality of protrusions which are to engage with or disengaged from the protrusions and rotates together with either the input member or the output member and is engaged to slide in an axial direction;
a guide ring which moves side by side in an axial direction and is installed not to be rotatable and comes into contact with the rotation clutch ring; and
an elastic member which pressures the rotation clutch to move an engaging position.

4. A manual wheelchair wheel according to claim 3, wherein said speed change cam comprises:
a first axial direction cam surface which is engaged with the speed change clutch ring or the guide ring by way of the radius direction through hole of the central shaft, and guides the speed change clutch ring to a disengagement position depending on the rotation direction position of the speed change cam, and allows the same to move to the engaging position; and
a second axial direction cam surface which guides the rotation clutch ring to a disengagement position, which allows the movement to the engaging position.

5. A manual wheelchair wheel according to claim 1, wherein said speed change cam comprises an elastic member pressurizing in one rotation direction so that either one position is maintained in the rotation direction.

6. A manual wheelchair wheel according to claim 1, wherein the rotation direction position of the speed change cam is controlled by means of the protrusion protruded from the speed change cam toward the direction opposite to the frame via the central shaft and the speed change lever engaged to the protrusion.

7. A manual wheelchair wheel according to claim 1, further comprising:
a speed change pin which is protruded from the speed change cam toward the direction of the frame via the central shaft;
a central shaft which has a through hole allowing for the speed change pin to move in the rotation direction; and
a control device which controls the rotation direction position of the speed change cam at the frame.

8. A manual wheelchair wheel according to claim 2, wherein said elastic member is formed of a coil spring or a wave washer.

9. A manual wheelchair wheel according to claim 1, further comprising:
a backward movement prevention clutch which can selectively prevent a backward movement by controlling the rotation direction position of the engaging member guide plate by further providing:
a braking member which is installed not to be rotatable with respect to the central shaft and has a plurality of pockets at an outer surface, with each pocket having a driving force transfer surface;
an output member which surrounds the braking member and has a driving force transfer surface at an inner surface;
a plurality of engaging members which are installed at each pocket and fit while coming into contact with the two driving force transfer surfaces;
an elastic member which is so configured to pressurize in a rotation direction that the engaging member can move backward in order for the engaging member to come into contact with the two driving force transfer surfaces; and
an engaging member guide plate which guides the engaging member not to come into contact with at least one surface between the two driving force transfer surfaces.

10. A manual wheelchair wheel according to claim 9, wherein said engaging member guide plate controls the rotation direction position of the engaging member guide plate by means of a braking member which rotatably passes through the speed change cam past the central shaft and a braking link engaged to the link.

11. A manual wheelchair wheel according to claim 9, wherein said engaging member guide plate has a control device capable of controlling, at the frame, the rotation direction position of the engaging member guide plate by providing a protrusion protruded in the direction of the frame.

12. A manual wheelchair wheel according to claim 7, wherein said control device comprises:
a connection part of a control device which is engaged at both sides of a body and accommodates the protrusion or speed change pin at the portions opposite to each wheel; and
a handle of one control device which is connected to the connection means of the control device installed at both sides, by way of a wire or a connection means similar with the wire, whereby both the wheels can be concurrently controlled.

13. A manual wheelchair wheel according to claim 1, wherein said central shaft comprises:
a frame support part which passes through a through hole formed at the frame and supports the frame;
a speed change part which accommodates the speed change cam and rotatably supports the input member and the output member; and
a fixing part which fixes the central shaft not to rotate, whereby the central shaft is engaged not disengaging from the frame and not rotating.

14. A manual wheelchair wheel according to claim 13, further comprising:
an ejector pin which is arranged passing through the speed change cam having the central shaft and the through hole; and
an end portion of the central shaft which size-decreases enough to freely pass through the through hole of the frame when an axial direction pressure is applied to the ejector pin, and expands when the pressure is not applied to the ejector pin, so that it is stably fixed at the through hole of the frame, whereby the device can be quickly engaged to and disengaged from the frame.

15. A manual wheelchair wheel according to claim 13, wherein the frame support part of the central shaft and the speed change part are provided in a prefabrication type, so the device can be applied to the through holes of various wheelchair frames in such a way to exchange only the frame support part.

16. A manual wheelchair wheel according to claim 1, wherein said output member is a hub surrounding the central shaft, the input member, the planetary gear train, the speed change clutch, the direction connection clutch and the speed change cam.

17. An apparatus for controlling a manual wheelchair which controls a manual wheelchair in which manual wheelchair wheels are installed at both sides of the frame, the manual wheelchair wheels being characterized in that a speed change pin controlling the speed change function with a speed change function and a backward movement prevention function at a hub of a wheel is provided, and a protrusion capable of controlling a backward movement prevention function is protruded toward the frame, comprising:
a wheel fixing device which supports the central shaft of the wheelchair wheel not to rotate;
a connection part of the control device which surrounds a speed change ring surrounding the wheel fixing device and accommodating the speed change pin and the wheel fixing device and accommodates a protrusion controlling the backward movement prevention function;
a handle manipulating the control device; and
a link connecting the connecting part and the handle.

18. An apparatus for controlling a manual wheelchair according to claim 17, wherein said connection part of the control device is connected to a handle via a wire and is engaged in such a way that a wire is pulled or loosened as the handle rotates, and said speed change ring and said braking ring each comprise a return spring applying a force in the direction that each wire is wound.

19. An apparatus for controlling a manual wheelchair according to claim 17, wherein said handle comprises:
a tensional force adjusting bolt which is surrounded by a tube and accommodates the wire by passing through the same and supports an end of the tube;
a bracket which has a female thread accommodating the tensional force adjusting bolt;
a speed change handle which is engaged with the speed change ring by way of a wire; and
a braking handle which is engaged with the baking ring by way of a wire, whereby the tensional force can be adjusted by tightening or loosening each tensional force adjusting bolt.
